(19) United States
(12) Patent Application Publication
(10) Pub. No.: US 2012/0072860 A1
(43) Pub. Date: Mar. 22, 2012

(54) TECHNIQUES TO PROVIDE PIVOT-BASED SEARCH FOR BUSINESS DATA

(75) Inventor: S Sridhar, Redmond, WA (US)

(73) Assignee: MICROSOFT CORPORATION, REDMOND, WA (US)

(21) Appl. No.: 12/884,474

(22) Filed: Sep. 17, 2010

(51) Int. Cl. G06F 3/048; G06F 17/30

(52) U.S. Cl. 715/765; 715/764; 707/758; 707/E17.014

(57) ABSTRACT

Techniques to provide a visual pivot-based search of business data may comprise displaying an entity of the business data as an interactive element. A searcher may select an entity as a pivot of a search, via the visual interactive interface. The visual interactive interface may then retrieve a first set of data associated with the pivot from the structured data, and display the first set of data as interactive elements. The display may be customized according to the searcher's role, defined preferences, and other settings. Other embodiments are described and claimed.

### BACKGROUND

Line-of-business (LOB) systems may provide support for managing business operations. LOB systems, such as, for example, Enterprise Resource Planning (ERP) and Customer Relationship Management (CRM), may contain large amounts of structured data about business operations. Searching the structured data, referred to as business data search, may be cumbersome for users. A successful search may be dependent on the user's ability to do one or more of: ask the appropriate question, translate the question to an appropriate query, evaluate the value of the answer, and, if needed, follow-up on the answer. It is with respect to these and other considerations that the present improvements have been needed.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

Various embodiments are generally directed to techniques to provide a visual interactive interface to search structured business data. Some embodiments are particularly directed to techniques to provide a visual pivot-based search for structured business data. In one embodiment, for example, a technique may comprise displaying an entity of the structured data as an interactive element. A searcher may select an entity as a pivot of a search, via the visual interactive interface. The visual interactive interface may then retrieve a first set of data associated with the pivot from the structured data, and display the first set of data as interactive elements. Other embodiments are described and claimed.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 illustrates an embodiment of a first system.

FIG. 2 illustrates an embodiment of structured business data.

FIG. 3 illustrates an embodiment of a visual interactive interface.

FIG. 4 illustrates an embodiment of an entity search.

FIG. 5 illustrates an embodiment of a relationship search.

FIG. 6 illustrates an embodiment of a lifecycle stage search.

FIG. 7 illustrates an embodiment of a logic flow.

FIG. 8 illustrates an embodiment of a computing architecture.

FIG. 9 illustrates an embodiment of a communications architecture.

### DETAILED DESCRIPTION

Various embodiments are directed to providing various search interfaces and mechanisms for business data search that may improve user productivity and provide context for search results. Embodiments may provide a visual interactive interface to the structured data and unstructured data. The visual interactive interface may allow a user to pivot data around various aspects of the structured data, such as an entity, a relationship, or a stage in a lifecycle. Embodiments may customize what structured data is displayed based upon the searcher's role, or other selections.

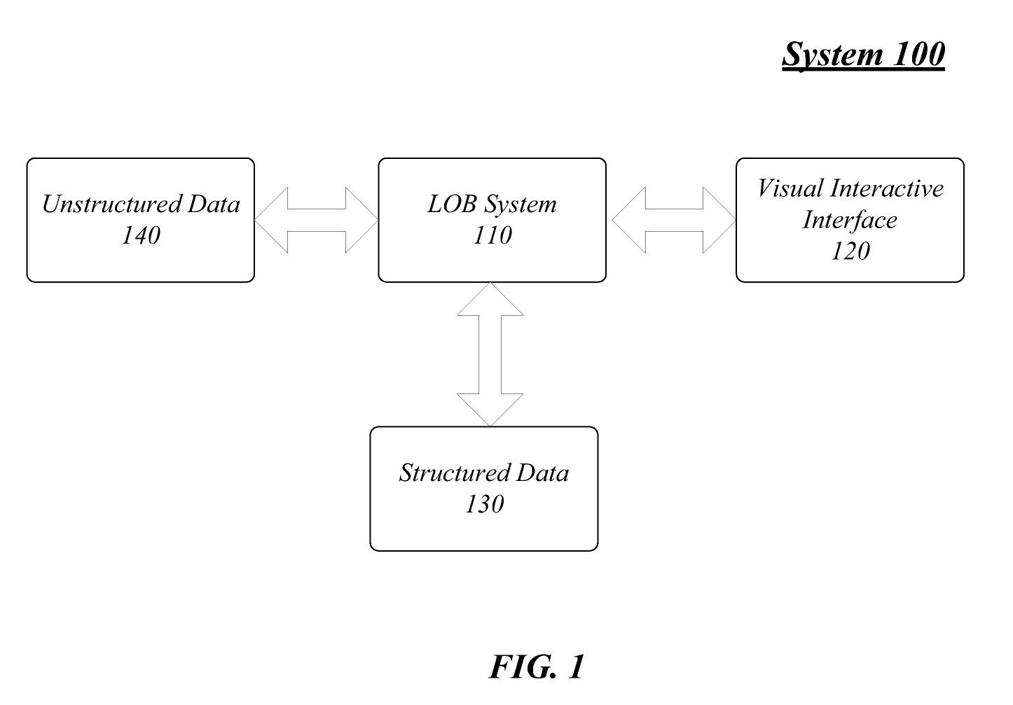

FIG. 1 illustrates a block diagram for a system 100 to provide a visual interactive interface to perform a business data search. In one embodiment, for example, the system 100 may comprise a computer-implemented system 100 having multiple components, such as a line of business system 110 and a visual interactive interface 120. As used herein the terms “system” and “component” are intended to refer to a computer-related entity, comprising either hardware, a combination of hardware and software, software, or software in execution. For example, a component can be implemented as a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers as desired for a given implementation. The embodiments are not limited in this context.

In the illustrated embodiment shown in FIG. 1, the system 100 may be implemented as part of an electronic device. Examples of an electronic device may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof. Although the system 100 as shown in FIG. 1 has a limited number of elements in a certain topology, it may be appreciated that the system 100 may include more or less elements in alternate topologies as desired for a given implementation.

The components may be communicatively coupled via various types of communications media. The components may coordinate operations between each other. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

In various embodiments, the system 100 may comprise a line of business (LOB) system 110. LOB system 110 may include, for example, Enterprise Resource Planning (ERP) or Customer Relationship Management (CRM). LOB system 110 may maintain business data in several forms. For example, LOB system 110 may maintain structured business data 130, and may allow access to unstructured business data 140.

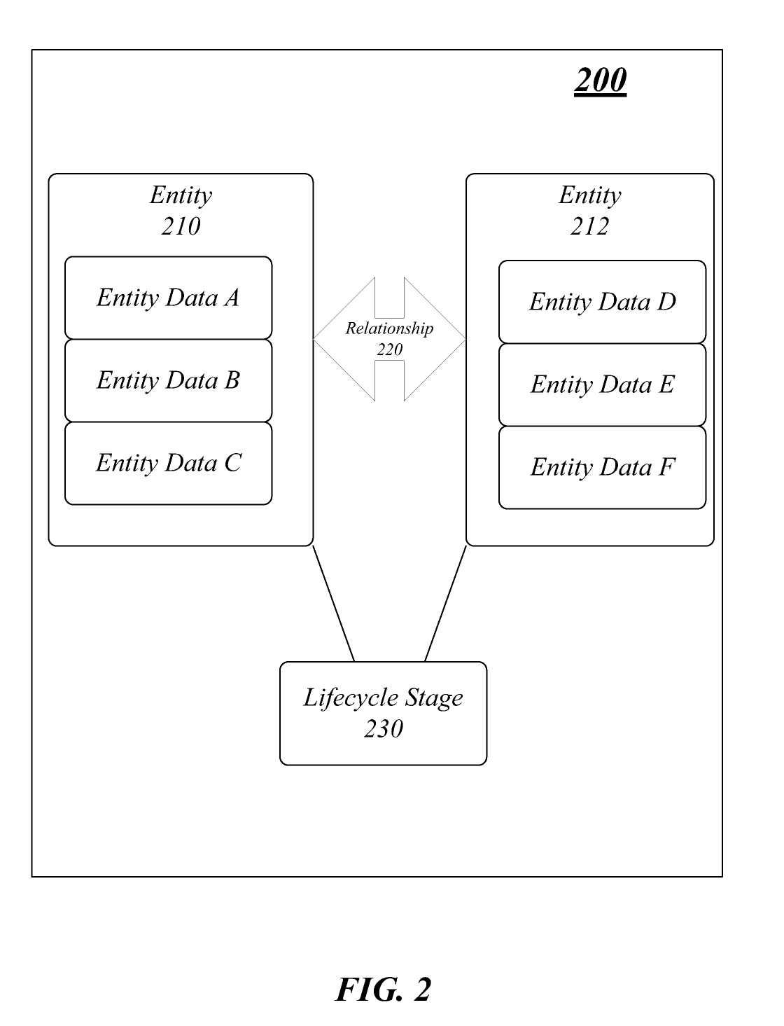

Structured data 130 may be one or more databases, such as, but not limited to, relational databases that organize data supporting a business operation. Structured data 130 is discussed further with respect to FIG. 2. Unstructured data 140 may include business-related data that is not usually stored in the structured data database, such as e-mail messages, memos, documents, voicemail messages and the like.

In various embodiments, the system 100 may comprise a visual interactive interface 120. Visual interactive interface 120 may be a component that operates on one or more computing devices in communication with LOB system 110. Embodiments of visual interactive interface 120 may operate locally on a computing device that is coupled to LOB system 110 via a network. Other embodiments of visual interactive interface 120 may be hosted by LOB system 110 and served over a network to a remote computing device.

Visual interactive interface 120 may provide a graphical representation of structured data 130 in an interactive, customizable view. Visual interactive interface 120 may present structured data 130 in several different formats, depending on the needs of the searcher. Visual interactive interface 120 may provide an alternative to conventional searching techniques, by allowing a searcher to navigate, or “click”, a visual representation of structured data 130 similar to the way a computer game player may zoom in and out of a game map. Embodiments may also provide a way to view unstructured data 140.

FIG. 2 illustrates a block diagram of an embodiment of structured business data 200. Structured business data 200 may be an embodiment of structured data 130. Structured business data 200 may include one or more entities, such as entity 210 and entity 212. Entities may be analogous to characters in a game. Entities may include entity types such as customers, vendors, employees, items for sale, etc.

An entity, such as entity 210, may have data associated with it, shown as entity data A, B, and C. A customer entity, for example, may have a customer identifier, an address, an account number, a phone number, or other relevant data for a customer. An employee entity may have an employee identifier, a title or role, a manager, a pay grade, or other relevant data for an employee.

Entities may be related to other entities via one or more relationships 220. For example, a customer entity may be related to one or more sales order entities based on purchases that the customer has made. In an embodiment, a unique identifier for an entity, such as a customer identifier, may be used as the key to link one entity to another in a relationship.

Structured business data 200 may also include lifecycle stage data 230. Lifecycle stage data 230 may include defined process steps for a business activity, such as the steps from receiving an order to order fulfillment to invoicing. For example, a quote may result in a sales order which, in turn, may be associated with one or more production orders, which, in turn, may lead to one or more shipments. Some of the items in the sales order may be under production, and some may have already been shipped. Lifecycle stage data 230 may be linked to other data, such as the other entities that were involved at a certain stage of the lifecycle, e.g. an employee or a vendor.

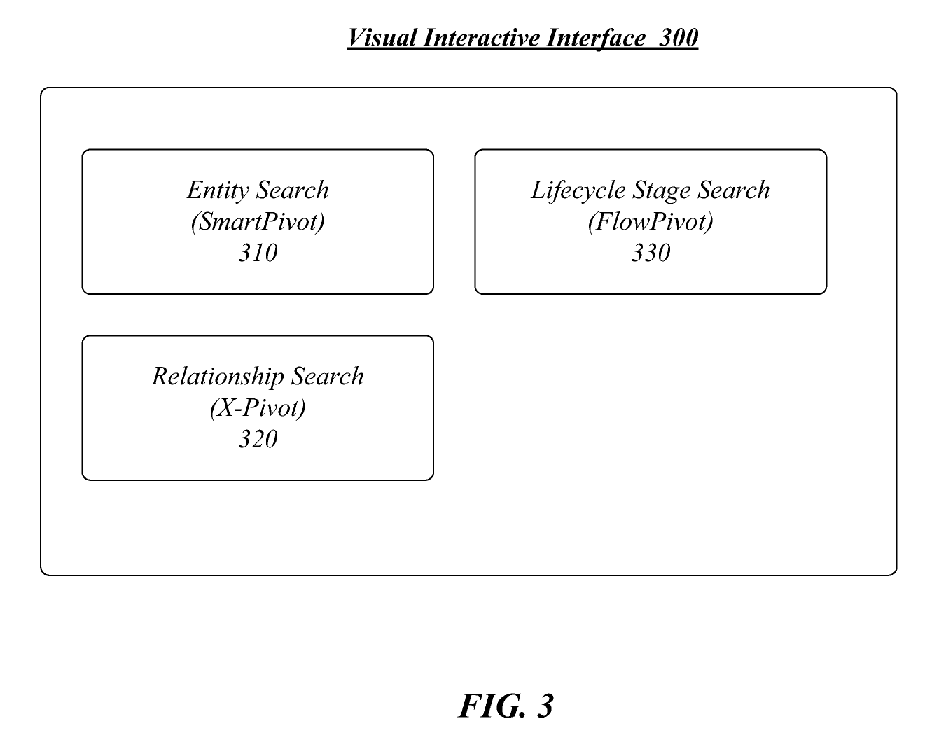

FIG. 3 illustrates a block diagram of an embodiment of a visual interactive interface 300. Visual interactive interface 300 may provide several different views of structured data 120. For example, visual interactive interface 300 may provide an entity search 310, also referred to herein as SmartPivot. Visual interactive interface 300 may provide a relationship search 320, also referred to herein as X-Pivot. Visual interactive interface 300 may provide a lifecycle stage search 330, also referred to herein as FlowPivot.

Business data searches often fall into three types of usage patterns: find, act, and related. The find usage pattern may be used to find information about a specific entity (e.g., “I want to find the billing information for a specific customer”; “I want to find the status of a specific order”). The searcher's goal here is “information-seeking”. The act usage pattern may be used to take action on or about a specific entity (e.g., “I want to update the billing address for a specific customer”; or, “I want to cancel a specific order”). Here, the search for the relevant entity may be a pre-requisite before any action can be taken on it. The searcher's goal here is “acting on the information” and “information-seeking” is implicit. The related usage pattern may be used to find or take action on another entity that is related or linked to a specific entity currently under review by the searcher (e.g., “I want to find the open orders for a specific customer”; “I want to find unpaid invoices for a specific supplier”; “I want to expedite the pending purchase orders for a specific item”.

Returning now to FIG. 3, SmartPivot 310 may search by pivoting the search on a single entity. SmartPivot 310 may be used to support the “Find” and “Act” usage patterns outlined earlier. Here, the searcher can use an entity (such as a customer) as a pivot to find specific information (such as billing or shipping address for a customer) or take action (such as update customer shipping address) on that entity. SmartPivot 310 may also be associated with standard pre-defined artifacts, such as views, reports, and charts, that help the searcher to use a specific entity of interest as a pivot for search and exploration. Each pivot entity in SmartPivot 310, such as a Customer, may be associated with one or more pre-defined artifacts, such as Past Due Customers, Inactive Customers, Customers on Hold. For example, if a searcher wants to find information about Past Due Customers, the searcher can select Customer entity, and select a “Past Due Customers” view. This may launch a view of all customers with past due accounts and the searcher may select a specific account. Alternatively, if the searcher wants to review the past due account of a specific customer, the searcher may directly specify the customer name or identifier as search parameters and then launch SmartPivot 310. The searcher may customize the view in terms of sorting, rearranging, or adding/deleting columns; apply additional filters; or save the result for future use. Based on the metadata associated with each pre-defined view, the searcher may also search with SmartPivot 310 to find the relevant pre-defined artifact quickly.

X-Pivot 320 may be an extension of SmartPivot 310 that not only provides a “big picture” view of the entity used as a pivot in SmartPivot 310, but also provides links to contextually related entities. X-Pivot 320 may be used to support the “Related” usage pattern outlined earlier. The contextual relationships between the entities are once again a conceptual relationship independent of the underlying schema. They may include a master-transaction relationship; a transaction-master relationship; a master-master relationship; and a transaction-transaction relationship.

X-Pivot 320 may visually represent the relationship between the pivot entity and contextually related entities in the form of a network diagram (entities as nodes and relationships as links). While there may be a large number of possible relationships, as indicated earlier, based on the 80-20 rule, only a selected subset that are of relevance or interest to the user are shown. X-Pivot 320 may serve as a visual anchor diagram that facilitates ad-hoc contextual exploration, or non-linear navigation, while providing the context and focus on the question that triggered the search. The use of additional visualization techniques such as fish-eye views can greatly enhance the user experience in terms of focus on the pivot entity and to enable follow-up actions or contextual exploration of related information as needed.

FlowPivot 330 may be an add-on to X-Pivot 320 and may be useful when the primary focus of the search is a single transaction entity instance (such as a specific order or invoice) only. FlowPivot 330 may leverage the fact that each transaction entity has a specific lifecycle and is likely to be in a specific stage of that lifecycle at any given instant. For example, a quote may result in a sales order which, in turn, may be associated with one or more production orders, which, in turn, may lead to one or more shipments. Some of the items in the sales order may be under production, and some may have already been shipped. So, when a searcher has a question “what is the status of order xyz?” the answer may vary depending on the state of the order in the lifecycle and the searcher's role and preference for details.

For each transaction entity instance used as a pivot, FlowPivot 330 may provide a graphical view of the transaction flow as part of the life cycle with appropriate annotations to describe the current status of the transaction. It can include colorful symbols to distinguish between what has been completed and what is pending or subject to bottleneck. For example, it can include links to all people who “touched” the transaction at various stages of the life cycle so far; or it can include a visual summary timeline representation of all updates to the transaction; or a link to all related upstream and downstream touch-points for that transaction. Thus, the visual answer to the question is likely to provide a far richer contextual understanding to the user.

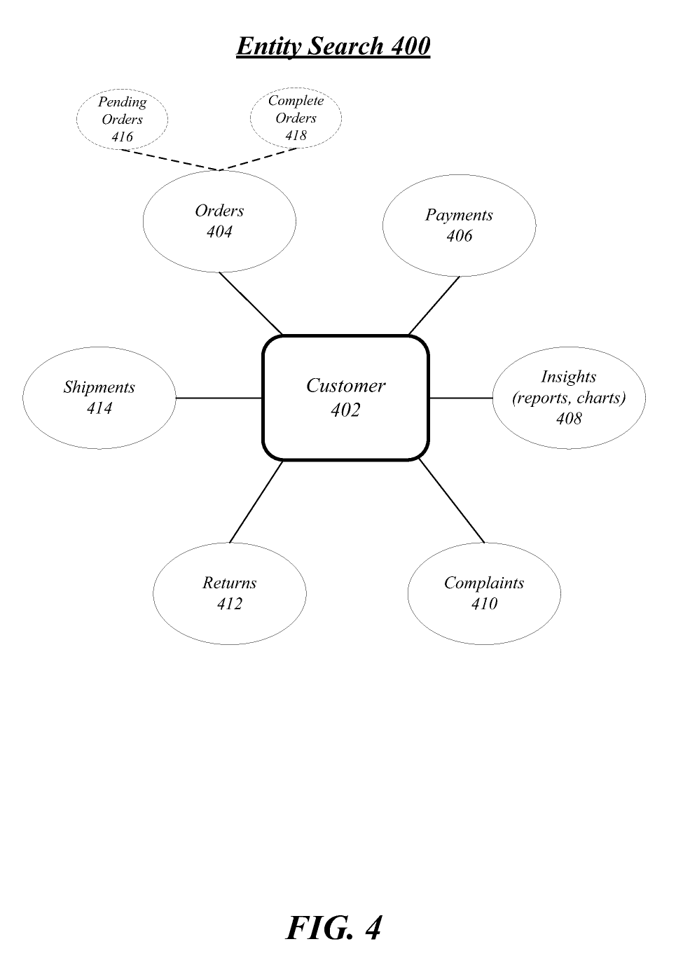

FIG. 4 illustrates an embodiment of an entity search 400 as may be provided, for example, by visual interactive interface 120. The example shown in FIG. 4 has a customer entity 402 as the pivot for the search. From a customer entity, the searcher has the option of next selecting from orders 404, payments 406, insights 408, complaints 410, returns 412 or shipments 414. Selecting one of these options may then open further search options to refine the search. For example, selecting orders 404 may then display the options of pending orders 416 and complete orders 418. In an embodiment, a searcher may open the entity search directly and select which entity to pivot on. Alternatively, the searcher may first enter a specific entity name, such as the customer name, and begin a more specific entity search that pivots on that particular entity instance.

Other aspects of or related to the entity may be accessed instead of or in addition to the aspects illustrated. In an embodiment, the role of the searcher within the business may dictate which aspects are provided. A searcher in the accounting department may not be shown complaints 410. The aspects shown in entity search 400 may be further customized. A particular searcher may select which options he wishes to see for each entity type. In an embodiment, visual interactive interface 120 may learn over time which selections are most used, and may only show the most used.

Once the searcher has reached the point where no further refining search options are available or needed, the business data that matches the options selected may be displayed in a view. The view may be, for example, in tabular or graph form. The view may be customizable as the pivot search options were. Further, the searcher may also be able to interact with the data in the view, such as selecting a particular customer from a list, or opening an editable invoice.

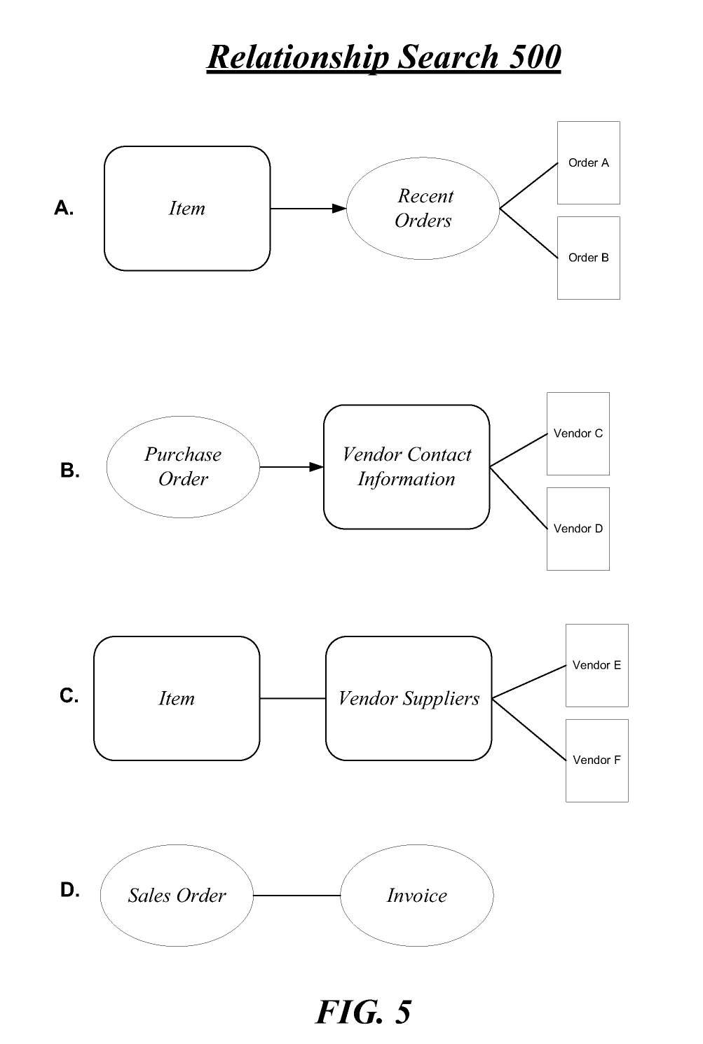

FIG. 5 illustrates several embodiments of a relationship search 500 as may be provided, for example, by visual interactive interface 120. Relationship search 500 (X-Pivot) may extend SmartPivot in a manner that leverages the structured information about relationships between different types of entities (master entity such as “customer” or “item”; transaction entity such as “purchase order”). In conventional LOB systems, these relationships are implicit or hidden from the user, although they may be represented in the underlying database. Example A illustrates a Master→Transaction relationship, for example, a Customer→Open Orders relationship, or an Item→Recent Orders relationship. Example B illustrates a Transaction→Master relationship, for example, a Purchase Order→Vendor contact information relationship; or a Sales Order→Customer information relationship. Example C illustrates a Master→Master relationship, for example, an Item→Vendors who supplied that item relationship; or a Customer→Item types ordered relationship. Example D illustrates a Transaction→Transaction relationship, for example a Sales Order→Invoice relationship, or a Sales Order→Production Order(s) relationship.

Embodiments of the relationship search may provide a more compelling search experience by depicting the most common relationships visually while empowering the searcher to explore the relationships interactively using pivots and in a way that is tailored to the searcher's role and/or preferences. For example, different colors, sizes or shapes may be used to denote the different types of entities. Next to the entity, additional summary information, such as, for example, the total count of purchase orders, or a small chart or image to show a trend, a thumbnail view, etc., may be provided. The result may provide a visual landscape that the searcher can explore and navigate easily to help with their search needs.

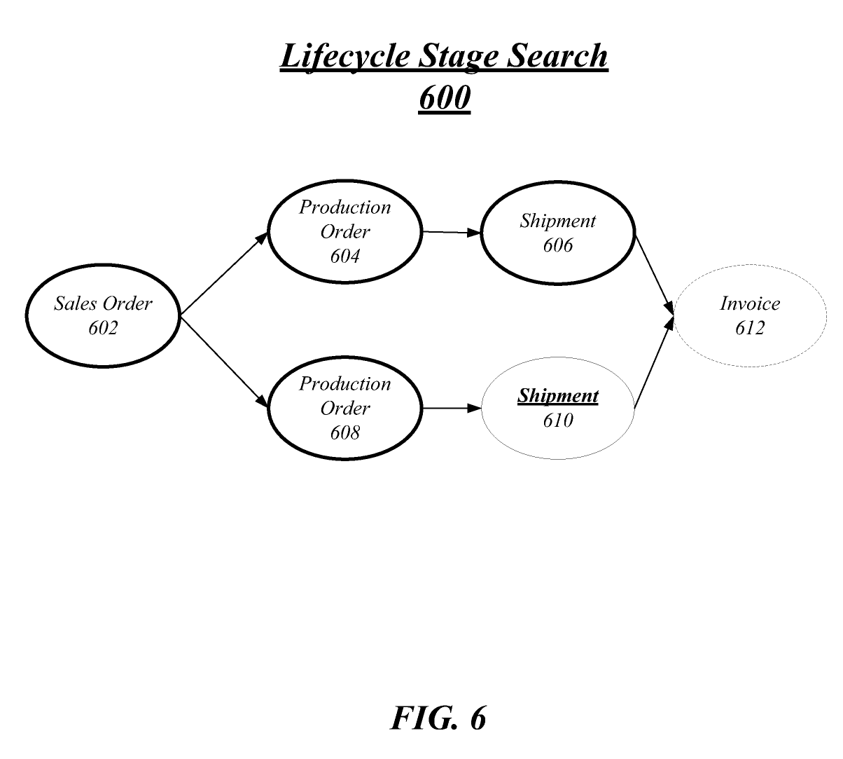

FIG. 6 illustrates an embodiment of a lifecycle stage search 600 as may be provided, for example, by visual interactive interface 120. In the illustrated example, a sales order fulfillment lifecycle is illustrated. As shown by the different line and type styles in FIG. 6, the sales order 602, production order 604, production order 608, and shipment 606 are all completed. Shipment 610 is in progress but not completed, and invoice 612 is not yet begun. The searcher can therefore see immediately at what stage the lifecycle is for the particular sales order. The searcher may then be able to select, for example, shipment 610 to obtain more information about why that lifecycle stage is not complete. The searcher may also be able to select a stage and obtain information about which employees or vendors are involved with that stage, or attributes related to that entity or stage, such as time consumed so far for that stage or completion percentage.

Operations for the above-described embodiments may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more hardware elements and/or software elements of the described embodiments or alternative elements as desired for a given set of design and performance constraints. For example, the logic flows may be implemented as logic (e.g., computer program instructions) for execution by a logic device (e.g., a general-purpose or specific-purpose computer).

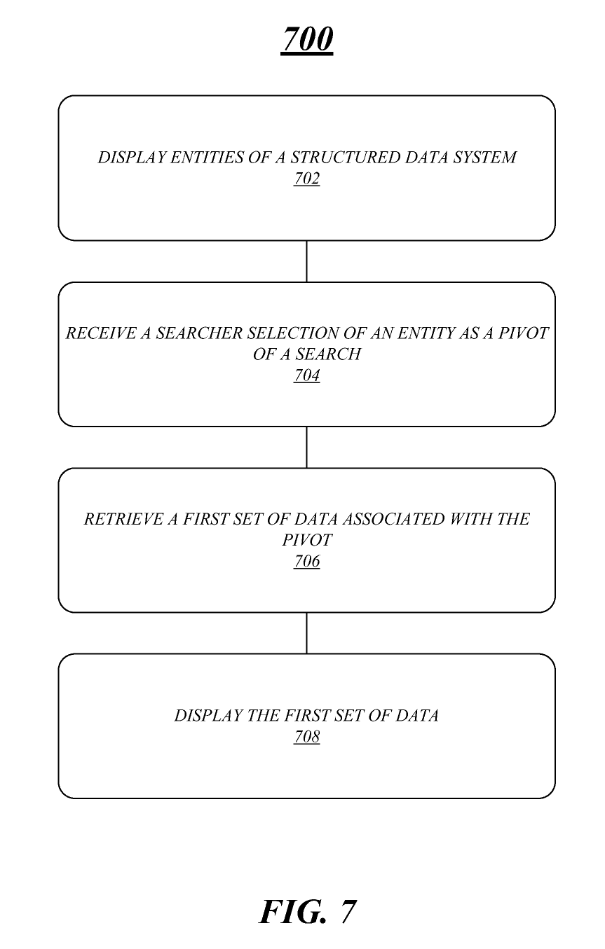

FIG. 7 illustrates one embodiment of a logic flow 700. The logic flow 700 may be representative of some or all of the operations for providing a visual interactive interface to a structured data system executed by one or more embodiments described herein.

In the illustrated embodiment shown in FIG. 7, the logic flow 700 may display one or more entities of the structured data system at block 702. For example, visual interactive interface 120 may display a customer entity, an employee entity, a transaction entity, etc. The entities may be displayed as interactive elements, such as, but not limited to icons, buttons, and the like.

The logic flow 700 may receive a searcher selection of an entity as a pivot of a search at block 704. For example, visual interactive interface 120 may receive a mouse click, a stylus point touch, a finger touch on a touch screen, or other indication of a selection of one of the displayed entities. The selected entity then becomes the pivot for searching for data in the structured data system that is related to the pivot.

The logic flow 700 may retrieve a first set of data associated with the pivot at block 706. For example, the first set of data may include one or more of: data about the pivot, a second entity, a relationship between the pivot and other entities, a lifecycle, an action to take on the pivot, or an artifact. In an embodiment, an artifact may include a pre-defined subset of entity data that may allow further filtering of data. Examples of artifacts for a customer may include, for example, past-due customers, inactive customers, customers on hold, etc.

The logic flow 700 may display the first set of data at block 708. For example, visual interactive interface 120 may retrieve data associated with a customer entity, such as, but not limited to, shipments, payments, orders, customer contact information, and complaints. The retrieved data may then be displayed as interactive elements. The display of the first set of data may be customized as described above. In an embodiment, the searcher may choose to use one of the displayed data as a pivot to drill-down further, or to find answers to follow-up questions that may have been triggered based on the searcher's review of the first set of data.

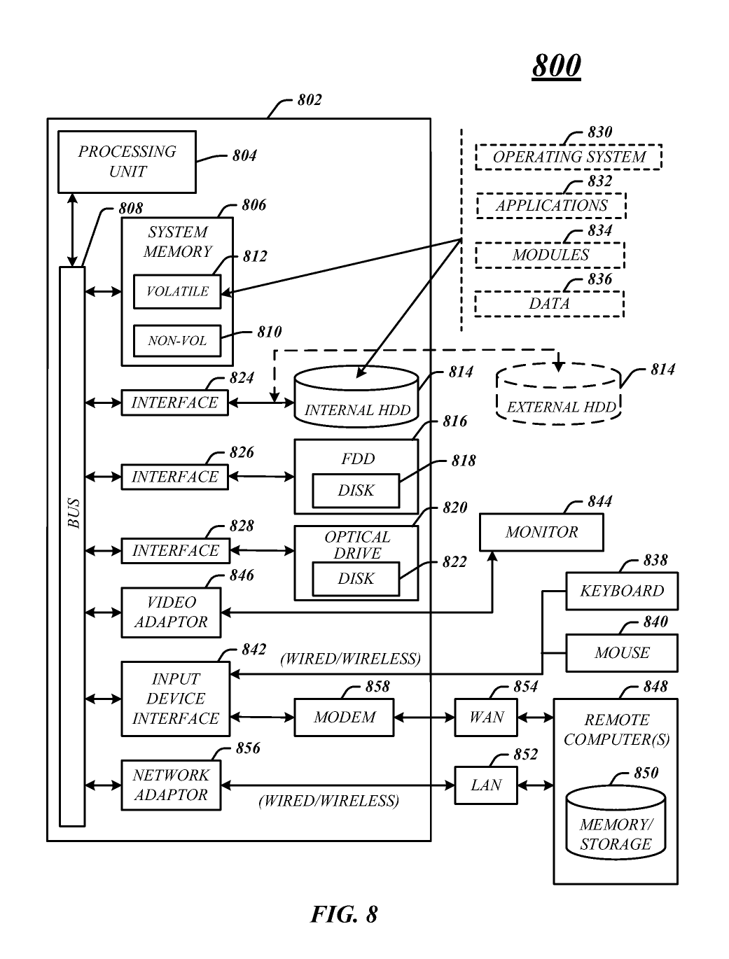

FIG. 8 illustrates an embodiment of an exemplary computing architecture 800 suitable for implementing various embodiments as previously described. The computing architecture 800 includes various common computing elements, such as one or more processors, co-processors, memory units, chipsets, controllers, peripherals, interfaces, oscillators, timing devices, video cards, audio cards, multimedia input/output (I/O) components, and so forth. The embodiments, however, are not limited to implementation by the computing architecture 800.

As shown in FIG. 8, the computing architecture 800 comprises a processing unit 804, a system memory 806 and a system bus 808. The processing unit 804 can be any of various commercially available processors. Dual microprocessors and other multi-processor architectures may also be employed as the processing unit 804. The system bus 808 provides an interface for system components including, but not limited to, the system memory 806 to the processing unit 804. The system bus 808 can be any of several types of bus structure that may further interconnect to a memory bus (with or without a memory controller), a peripheral bus, and a local bus using any of a variety of commercially available bus architectures.

The system memory 806 may include various types of memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. In the illustrated embodiment shown in FIG. 8, the system memory 806 can include non-volatile memory 810 and/or volatile memory 812. A basic input/output system (BIOS) can be stored in the non-volatile memory 810.

The computer 802 may include various types of computer-readable storage media, including an internal hard disk drive (HDD) 814, a magnetic floppy disk drive (FDD) 816 to read from or write to a removable magnetic disk 818, and an optical disk drive 820 to read from or write to a removable optical disk 822 (e.g., a CD-ROM or DVD). The HDD 814, FDD 816 and optical disk drive 820 can be connected to the system bus 808 by a HDD interface 824, an FDD interface 826 and an optical drive interface 828, respectively. The HDD interface 824 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 810, 812, including an operating system 830, one or more application programs 832, other program modules 834, and program data 836. The one or more application programs 832, other program modules 834, and program data 836 can include, for example, the LOB system 110 and visual interactive interface 120.

A user can enter commands and information into the computer 802 through one or more wire/wireless input devices, for example, a keyboard 838 and a pointing device, such as a mouse 840. Other input devices may include a microphone, an infra-red (IR) remote control, a joystick, a game pad, a stylus pen, touch screen, or the like. These and other input devices are often connected to the processing unit 804 through an input device interface 842 that is coupled to the system bus 808, but can be connected by other interfaces such as a parallel port, IEEE 1394 serial port, a game port, a USB port, an IR interface, and so forth.

A monitor 844 or other type of display device is also connected to the system bus 808 via an interface, such as a video adaptor 846. In addition to the monitor 844, a computer typically includes other peripheral output devices, such as speakers, printers, and so forth.

The computer 802 may operate in a networked environment using logical connections via wire and/or wireless communications to one or more remote computers, such as a remote computer 848. The remote computer 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wire/wireless connectivity to a local area network (LAN) 852 and/or larger networks, for example, a wide area network (WAN) 854. Such LAN and WAN networking environments are commonplace in offices and companies, and facilitate enterprise-wide computer networks, such as intranets, all of which may connect to a global communications network, for example, the Internet.

When used in a LAN networking environment, the computer 802 is connected to the LAN 852 through a wire and/or wireless communication network interface or adaptor 856. The adaptor 856 can facilitate wire and/or wireless communications to the LAN 852, which may also include a wireless access point disposed thereon for communicating with the wireless functionality of the adaptor 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wire and/or wireless device, connects to the system bus 808 via the input device interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with wire and wireless devices or entities using the IEEE 802 family of standards, such as wireless devices operatively disposed in wireless communication (e.g., IEEE 802.7 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and BluetoothTM wireless technologies. Thus, the communication can be a predefined structure as with a conventional network or simply an ad hoc communication between at least two devices. Wi-Fi networks use radio technologies called IEEE 802.7x (a, b, g, etc.) to provide secure, reliable, fast wireless connectivity. A Wi-Fi network can be used to connect computers to each other, to the Internet, and to wire networks (which use IEEE 802.3-related media and functions).

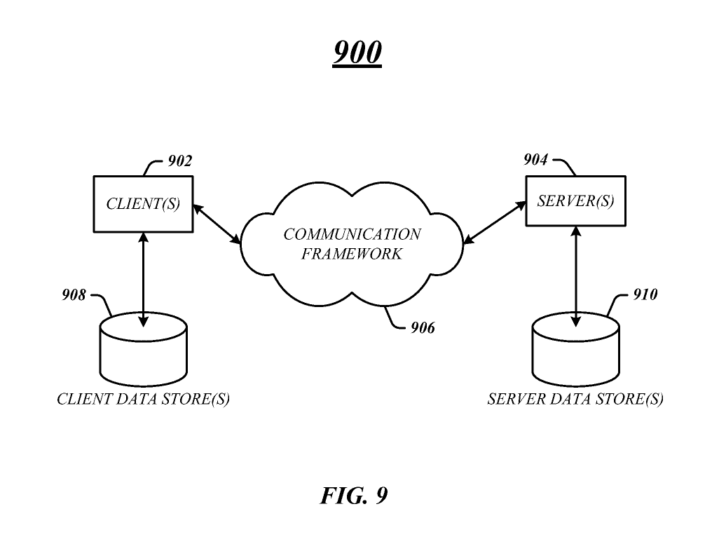

FIG. 9 illustrates a block diagram of an exemplary communications architecture 900 suitable for implementing various embodiments as previously described. The communications architecture 900 includes various common communications elements, such as a transmitter, receiver, transceiver, radio, network interface, baseband processor, antenna, amplifiers, filters, and so forth. The embodiments, however, are not limited to implementation by the communications architecture 900.

As shown in FIG. 9, the communications architecture 900 comprises includes one or more clients 902 and servers 904. The clients 902 may implement the client systems 310, 400. The servers 904 may implement the server system 330. The clients 902 and the servers 904 are operatively connected to one or more respective client data stores 908 and server data stores 910 that can be employed to store information local to the respective clients 902 and servers 904, such as cookies and/or associated contextual information.

The clients 902 and the servers 904 may communicate information between each other using a communication framework 906. The communications framework 906 may implement any well-known communications techniques, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The clients 902 and the servers 904 may include various types of standard communication elements designed to be interoperable with the communications framework 906, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. One possible communication between a client 902 and a server 904 can be in the form of a data packet adapted to be transmitted between two or more computer processes. The data packet may include a cookie and/or associated contextual information, for example.

Various embodiments may be implemented using hardware elements, software elements, or a combination of both. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may comprise an article of manufacture. An article of manufacture may comprise a storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method for providing a visual interactive interface to a structured data system, comprising:
displaying at least one entity of the structured data system as an interactive element;
receiving a searcher selection of an entity as a pivot of a search, via the visual interactive interface;
retrieving a first set of data associated with the pivot; and
displaying the first set of data as interactive elements.

2. The method of claim 1, wherein displaying comprises:
displaying a customized view of the first set of data.

3. The method of claim 2, wherein displaying a customized view comprises at least one of:
displaying a customized view based on a role of the searcher;
displaying a customized view based on a specification of a preferred view by the searcher;
displaying a customized view based on a determination of a most frequently used view; and
displaying a customized view based on a determination of a most recently used view.

4. The method of claim 1, further comprising:
receiving a second user selection from the first set of data;
filtering the first set of data with the second user selection to produce a second set of data; and
displaying the second set of data.

5. The method of claim 1, further comprising:
displaying a network diagram comprising the pivot, at least one entity contextually related to the pivot, and relationships among the pivot and the entities shown as links between the pivot and the entities.

6. The method of claim 1, wherein the pivot is a single transaction entity instance and wherein displaying comprises:
displaying stages of a lifecycle associated with the single transaction entity instance.

7. The method of claim 6, further comprising at least one of:
annotating a displayed stage of the lifecycle according to a status of the stage;
displaying links to entities related to a displayed stage of the lifecycle;
displaying a timeline of updates to the single transaction entity; and
displaying a link to upstream and downstream stages for the single transaction entity.

8. The method of claim 1, wherein the first set of data comprises at least one of:
a second entity, a relationship between entities, a lifecycle stage, an action to take on the pivot, or an artifact.

9. The method of claim 8, wherein an artifact comprises a pre-defined filter on an entity.

10. An article comprising a storage medium containing instructions that when executed enable a system to:
provide a visual interactive interface to a line of business system comprising structured data and unstructured data, the visual interactive interface operative to:
display at least one entity of the structured data as an interactive element;
receive a searcher selection of an entity as a pivot of a search;
retrieve a first set of data associated with the pivot from the structured data; and
display the first set of data as interactive elements.

11. The article of claim 10, further comprising instructions that when executed enable the system to customize the display of the first set of data according to at least one of:
a role of the searcher;
a specification of a preferred view by the searcher;
a determination of a most frequently used view; and
a determination of a most recently used view.

12. The article of claim 10, further comprising instructions that when executed enable the system to display a network diagram comprising the pivot, at least one entity contextually related to the pivot, and relationships among the pivot and the entities shown as links between the pivot and the entities.

13. The article of claim 10, wherein the pivot is a single transaction entity instance, and the article further comprising instructions that when executed enable the system to display stages of a lifecycle associated with the single transaction entity instance.

14. The article of claim 13, further comprising instructions that when executed enable the system to:
annotate a displayed stage of the lifecycle according to a status of the stage;
display links to entities related to a displayed stage of the lifecycle;
display a timeline of updates to the single transaction entity; and
display a link to upstream and downstream stages for the single transaction entity.

15. The article of claim 10, further comprising instructions that when executed enable the system to retrieve a second set of data from the unstructured data.

16. An apparatus, comprising:
a computing device in communication with a line of business system, the computing device comprising a processor, a display, and a visual interactive interface operative on the processor, the visual interactive interface operative to:
display at least one entity of the line of business system as an interactive element on the display;
receive a searcher selection of an entity as a pivot of a search;
retrieve a first set of data associated with the pivot from the structured data; and
display the first set of data as interactive elements.

17. The apparatus of claim 16, wherein the visual interactive interface is one of a stand-alone application operative on the computing device and an application hosted by the line of business system.

18. The apparatus of claim 16, the visual interactive interface further operative to customize the display of the first set of data according to at least one of:
a role of the searcher;
a specification of a preferred view by the searcher;
a determination of a most frequently used view; and
a determination of a most recently used view.

19. The apparatus of claim 16, the visual interactive interface further operative to display a network diagram comprising the pivot, at least one entity contextually related to the pivot, and relationships among the pivot and the entities shown as links between the pivot and the entities.

20. The apparatus of claim 16, wherein the pivot is a single transaction entity instance, and visual interactive interface further operative to:
display stages of a lifecycle associated with the single transaction entity instance;
annotate a displayed stage of the lifecycle according to a status of the stage;
display links to entities related to a displayed stage of the lifecycle;
display a timeline of updates to the single transaction entity; and
display a link to upstream and downstream stages for the single transaction entity.
